(19) United States
(12) Patent Application Publication
(10) Pub. No.: US 2003/0167174 A1
(43) Pub. Date: Sep. 4, 2003

(54) Automatic audio recorder-player and operating method therefor

(75) Inventors: Serhan Dagtas, Shrub Oak, NY (US); Nevenka Dimitrova, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V.

(21) Appl. No.: 10/086,849

(22) Filed: Mar. 1, 2002

(51) Int. Cl. G10L 11/00

(52) U.S. Cl. 704/275

(57) ABSTRACT

An audio recorder-player includes M tuners that generate N audio signals transmitted by N audio sources, an analyzer that extracts R×N audio signal characteristics from the N audio signals, a memory that stores the R×N audio signal characteristics, and output circuitry that reproduces an audio signal corresponding to one of the N audio signals responsive to selection of at least one of the R×N audio signal characteristics, where R is a positive integer and M and N are positive integers greater than 1. If desired, the audio recorder-player advantageously can be included in one of a radio, a computer, or a set-top box. Methods for operating the audio recorder-player are also described.

### BACKGROUND OF THE INVENTION

The present invention relates generally to audio entertainment systems. More specifically, the present invention relates to audio entertainment systems incorporating an audio recorder-player permitting recording, processing, and selected playback of recorded audio signals. Advantageously, the audio recorder-player permits the user to play live or recorded audio selections based on the processing results for previously recorded audio signal samples.

Software for performing speech recognition on either live audio signals or audio signal files with acceptable accuracy, i.e., better than 95%, is commercially available. For example, U.S. Pat. Nos. 4,277,644 and 6,101,467 cover various aspects of speech recognition software. Moreover, comparable methods for characterizing audio content are known. U.S. Pat. Nos. 6,054,646 and 6,173,260 cover methods for characterizing music by beat, energy, pitch, etc. In addition, most automobile radio include a scan mode, which allows to the radio to automatically step through the AM or FM frequency band, stopping for a few seconds at each existing audio signal source, i.e., channel.

Despite both the strides made in recent years and the ongoing developments with respect to both speech recognition and audio signal analysis and characterization, the trend in current audio products is either business as usual, i.e., relying on market forces to differentiate between the various types of programming, or relying on a single entity to sort music into various channels. These channels are then broadcast via satellite or over the Internet.

In recent years, several “enhanced radios” have been introduced (most of which have since been withdrawn from the market), wherein an unknown “audio programmer” selects the music going into multiple channels. For example, several audio channels sorted by content are available over the Internet from services or providers such as Spinner. The recently introduced XM Radio provides upwards of 100 channels of professionally programmed music, sport, news, et cetera. However, the radio employed in receiving the satellite broadcasts is no more functional than the automobile radios offered a decade ago. The alternative Kerbango radio (and tuning service) provided some advanced functionality by providing a database of audio sources available via the Internet, i.e., the content is classified in accordance with a company's standards and not a user's preferences. In contrast, the Internet Radio appliance offered by AudioRamp.com stores approximately 1000 MP3 audio files. However, since the user obtains such files from online streaming sources, the audio files again are selected by the streaming sources and not the user.

What is needed is an audio recorder-player allowing audio signals from multiple audio sources to be analyzed and characterized so that the audio source(s) replayed by the user are selected in accordance with the user's preferences. It would be beneficial if the audio recorder-player could be incorporated into a number of devices including, but not limited to, automobile entertainment systems, personal computers, set-top boxes, etc. It would be desirable if the audio recorder-player could process audio signal samples containing either voice or music. It would also be desirable if the audio recorder-player could respond to high-level voice commands. Lastly, an audio recorder-player wherein selected elements could be either real or virtual, i.e., a software function instantiated by a processor, would be particularly advantageous.

### SUMMARY OF THE INVENTION

Based on the above and foregoing, it can be appreciated that there presently exists a need in the art for an audio recorder/player and corresponding operating method that overcome the above-described deficiencies. The present invention was motivated by a desire to overcome the drawbacks and shortcomings of the presently available technology, and thereby fulfill this need in the art.

According to one aspect, the present invention provides an audio recorder-player, including a first device for tuning to at least two audio sources to thereby generate first and second audio signals, a second device for generating characterizing first and second audio signal characteristics responsive to the first and second audio signals, a third device for storing both the first and second audio signals and the first and second audio signal characteristics, and a fourth device for reproducing one of the first and second audio signals responsive to selection of one of the first and second audio signal characteristics. If desired, the audio recorder-player advantageously can be included in one of a radio, a computer, or a set-top box. Beneficially, the storing device can include a hard disk. In an exemplary embodiment, the tuning device includes software routines instantiated by a processor. Moreover, the generating device can include a voice recognition routine instantiated by a processor. If desired, the audio recorder-player also includes a device for applying a control signal generated in response to a spoken command to thereby control the reproducing device.

According to another aspect, the present invention provides an audio recorder-player, including M tuners that generate N audio signals transmitted by N audio sources, an analyzer that extracts R×N audio signal characteristics from the N audio signals, a memory that stores the R×N audio signal characteristics, and output circuitry that reproduces an audio signal corresponding to one of the N audio signals responsive to selection of at least one of the R×N audio signal characteristics, where R is a positive integer and M and N are positive integers greater than 1. If desired, each of the M tuners includes a software routine instantiated by a processor. In addition, the analyzer advantageously may include a voice recognition routine instantiated by a processor. In an exemplary case, the voice recognition routine can be employed to generate signals that control the output circuitry in response to a spoken command.

According to a further aspect, the present invention provides an operating method for an audio recorder-player including M tuners, an analyzer, a storage device, and audio output circuitry, including steps for operating the M tuners to acquire N audio signals from N audio sources, operating the analyzer to characterize the N audio signals and generate R×N audio signal characteristics, storing both the N audio signals and the R×N audio signal characteristics in the storage device, and reproducing a selected one of the N audio signals via the audio output circuitry responsive to selection of one of the R×N audio signal characteristics, where R is a positive integer and M and N are positive integers greater than 1. If desired, M can be equal to N, particularly when each of the tuners is a tuner routine instantiated by a processor. In an exemplary case, one of the N audio signals is stored while one of the M tuners is tuned to a respective one of the N audio sources, and the R×N audio signal characteristics are extracted from the stored N audio signals. Preferably, selected ones of the R×N audio signal characteristics correspond to tempo, tone, and energy for music included in the N audio signals. Alternatively, selected ones of the R×N audio signal characteristics correspond to words extracted from speech included in the N audio signals. In any event, the operating method can include a step for generating a control signal for causing the audio output circuitry to reproduce the selected one of the N audio signals responsive to a user selected one of the R×N audio signal characteristics.

According to a still further aspect, the present invention provides an operating method for an audio recorder-player including M tuners, an analyzer, a storage device, and audio output circuitry, including steps for operating the M tuners to acquire N audio signal segments from N audio sources, operating the analyzer to characterize the N audio signal segments and generate R×N audio signal characteristics, storing the R×N audio signal characteristics in the storage device, and reproducing audio signals generated by a selected one of the N audio sources via the audio output circuitry responsive to selection of one of the R×N audio signal characteristics, where R is a positive integer and M and N are positive integers greater than 1. If desired, M can be equal to N. In an exemplary case, one of the N audio signal segments is temporarily stored each time one of the M tuners is tuned to a respective one of the N audio sources, and the R×N audio signal characteristics are extracted from the temporarily stored N audio signal segments. Preferably, selected ones of the R×N audio signal characteristics correspond to tempo, tone, and energy for music included in the N audio signal segments. Alternatively, selected ones of the R×N audio signal characteristics correspond to words extracted from speech included in the N audio signal segments. In any event, the operating method can include a step for generating a control signal for causing the audio output circuitry to reproduce the selected one of the N audio signals responsive to a user selected one of the R×N audio signal characteristics.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high-level block diagram of an audio recorder-player according to a first preferred embodiment according to the present invention;

FIG. 2 is a high-level block diagram of an audio recorder-player according to a second preferred embodiment according to the present invention;

FIG. 3 is a flowchart illustrating various operational aspects of the audio recorder-players illustrated in FIGS. 1 and 2; and

FIGS. 4A and 4B illustrate alternative exemplary memory organizations that can be employed in the audio recorder-players depicted in FIGS. 1 and 2.

### DETAILED DESCRIPTION OF THE PREFERRED EMBODIMENTS

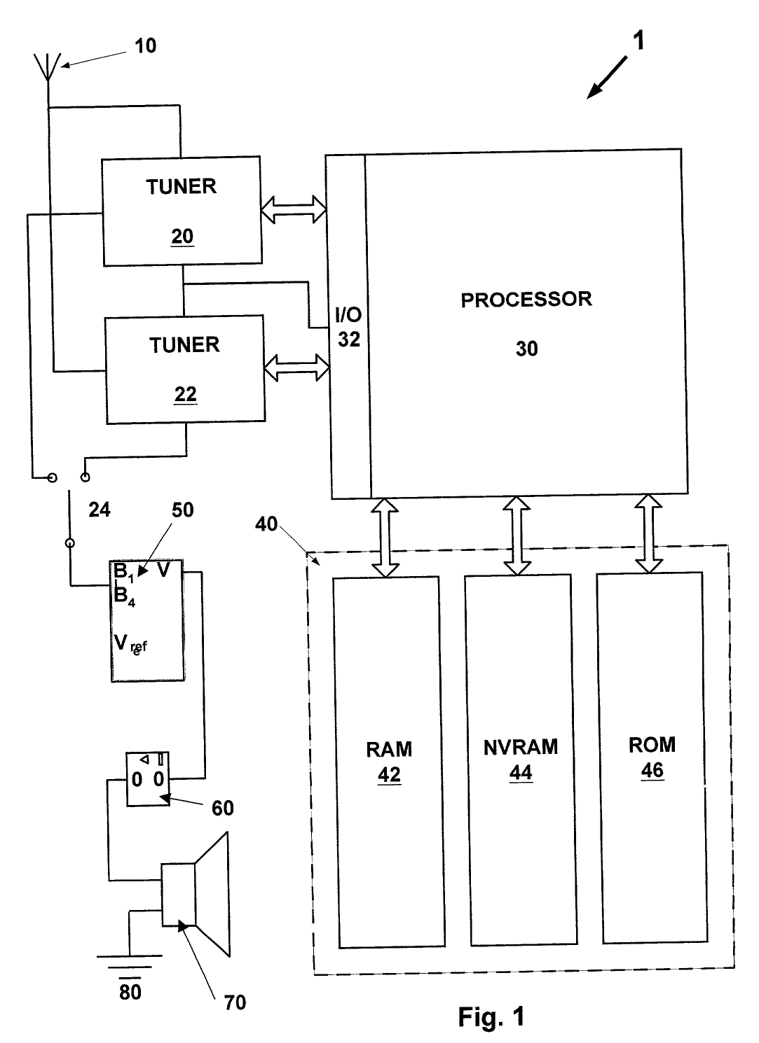

A first preferred embodiment according to the present invention will now be described with reference to FIG. 1, which is a high-level block diagram of an audio recorder-player 1. Preferably, the audio recorder-player includes tuners 20 and 22 operatively coupled to an antenna 10. Preferably, each of the tuners 20, 22 are controlled by a processor 30, which advantageously provides control signals to the tuners via and input/output (I/O) port 32.

The processor 30 is operatively coupled to a random access memory (RAM) 42, a nonvolatile random access memory (NVRAM) 44, and a read only memory (ROM) 46. RAM 42 provides temporary storage for data generated by programs and routines instantiated by the processor 30 while NVRAM stores characterization results, i.e., data indicative of audio signal characteristics. ROM 46 stores the programs and permanent data used by these programs. It should be mentioned at this point that the processor 30 advantageously can be one of a microprocessor or a digital signal processor (DSP); in an exemplary case, the processor 30 can include both types of processors. In another exemplary case, the processor is a DSP which instantiates an analyzer, which operates as, discussed in greater detail below. It should also be mentioned that NVRAM 44 advantageously can be a static RAM (SRAM) or ferromagnetic RAM (FERAM) or the like while the ROM 46 can be a SRAM or electrically programmable ROM (EPROM or EEPROM), which would permit the programs and “permanent” data to be updated as new program versions become available. Alternatively, the functions provided by the RAM 42, the NVRAM 44, and the ROM 46 advantageously can be embodied in the present invention as a single hard drive. In that case, the discrete memories 42, 44, and 46 can be incorporated into a single memory device 40, e.g., a hard drive or disk.

Each of the tuners 20, 22 is operatively connected to output circuitry which, in an exemplary case, includes a selector switch 24, a digital to analog converter (DAC) 50, an amplifier 60, and a speaker 70. The various devices in the output circuitry are coupled to ground 80 in a conventional manner. It will be noted that when the tuners 20, 22 are analog devices, the DAC 50 advantageously can be omitted. However, since the output of the tuners 20, 22 are also provided to the processor 30 via the I/O port 32 for analysis and characterization, the tuners 20, 22 are illustrated as being digital devices, i.e., tuners with digital outputs for simplicity. Other arrangements will occur to one of ordinary skill in the art upon reading the instant disclosure and all such arrangements are considered to be within the scope of the present invention.

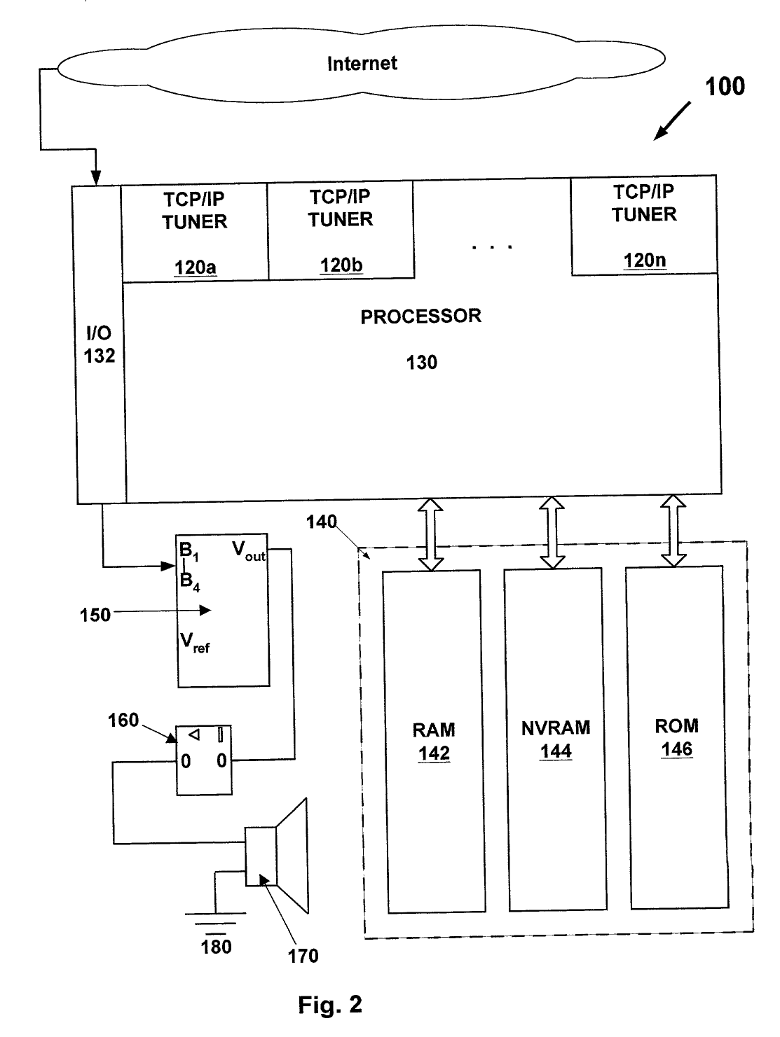

It will be noted that the configuration of the audio recorder-player 1 illustrated in FIG. 1 is suitable for inclusion in devices that receive multiple audio source transmission over the air or via land lines, e.g., cable. Such devices include radios, i.e., automobile radios, satellite radios, etc., and set-top boxes (STBs), e.g., cable and satellite STBs. It will also be noted that the speed at which the audio recorder-player 1 analyzes and characterizes audio content is constrained by the number of tuners included in the device. For example, when audio recorder-player 1 includes only the illustrated tuners 20, 22 (although more advantageously can be included), and tuner 20 is playing the users favorite radio station, only tuner 22 is available for audio sampling. Since each sample is several seconds along, since the quality of analysis and characterization of each station's content is generally inversely proportional to the number of samples for that station, and since there is a finite gap in the received audio signal as the tuner is tuned from one audio source to another, it may require minutes or even hours to analyze and characterize all audio sources serving a particular listening audience. It would be advantageous if a device capable of operating multiple virtual tuners, e.g., tuners instantiated by a processor reading a stored tuner program or software routine, were available. Such a device is illustrated in FIG. 2.

Another exemplary embodiment according to the present invention is illustrated in FIG. 2, which is high-level block diagram of an audio recorder-player 100. It will be appreciated that several of the components employed in audio recorder-player 100 are software devices, as discussed in greater detail below. It will be appreciated that the audio recorder-player 100 advantageously can be connected to various streaming audio sources; at one point there were as many as 2500 such sources in operation in the United States alone. Preferably, the processor 130 receives these streaming audio sources via an I/O port 132 from the Internet. It will be noted that the actual hardware required to connect to the Internet includes a modem, e.g., an analog, cable, or DSL modem or the like, and, in some cases, a network interface card (NIC). Such conventional devices, which form no part of the present invention, will not be discussed further.

Still referring to FIG. 2, the processor 130 is preferably connected to a RAM 142, a NVRAM 144, and ROM 146 collectively forming memory 140. As discussed above with respect to FIG. 1, RAM 142 provides temporary storage for data generated by programs and routines instantiated by the processor 130 while NVRAM 144 stores characterization results, i.e., data indicative of audio signal characteristics. ROM 146 stores the programs and permanent data used by these programs. It should be mentioned that NVRAM 144 advantageously can be a static RAM (SRAM) or ferromagnetic RAM (FERAM) or the like while the ROM 146 can be a SRAM or electrically programmable ROM (EPROM or EEPROM), which would permit the programs and “permanent” data to be updated as new program versions become available. Alternatively, the functions of RAM 142, NVRAM 144, and the ROM 146 advantageously can be embodied in the present invention as a single hard drive, i.e., the single memory device 140. It will be appreciated that when the processor 30 (130) includes multiple processors, each of the processors advantageously can either share memory device 140 or have a respective memory device. Other arrangements, e.g., all DSPs employ memory device 140 and all microprocessors employ memory device 140A (not shown), are also possible.

It will be appreciated from FIG. 2 that the processor 130 instantiates as many virtual tuners, e.g., TCP/IP tuners 120a-120n, as processor resources permit. One of the TCP/IP tuners 120a-120n can be operatively connected to output circuitry which, in an exemplary case, includes an optional digital to analog converter (DAC) 150, an amplifier 160, and a speaker 170 via I/O port 132. The various devices in the output circuitry are coupled to ground 180 in a conventional manner. Again, other arrangements will occur to one of ordinary skill in the art upon reading the instant disclosure and all such arrangements are considered to be within the scope of the present invention. It will be noted that when the audio recorder-player includes a digital amplifier 160, i.e., no DAC required, DAC 150 can be omitted.

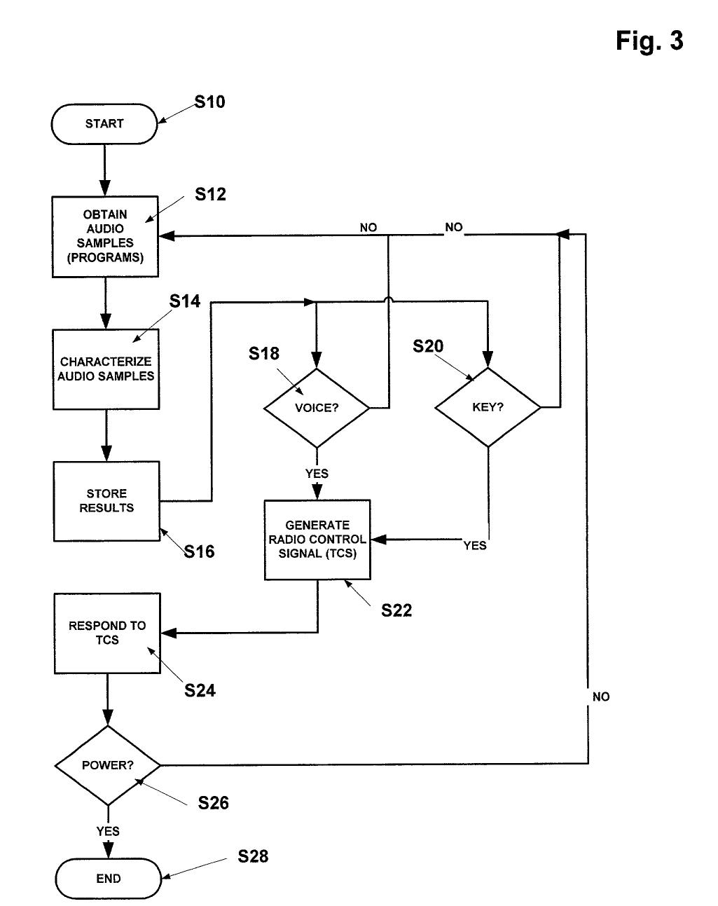

The overall operation of the audio recorder-players 1 and 100 will now be described while referring to FIG. 3, which illustrates a flowchart of the method of operating an audio recorder-player according to the present invention. During step S10, the audio recorder-player is energized and initialized. For either of the audio recorder-players illustrated in FIGS. 1 and 2, the initialization routine advantageously can include initializing the RAM 42 (142) to accept digital audio signal samples; moreover, the processor 30 (130) of the audio recorder-player 1 (100) can retrieve both software from ROM 46 (146) and read the audio signal characteristics previously stored in NVRAM 44 (144).

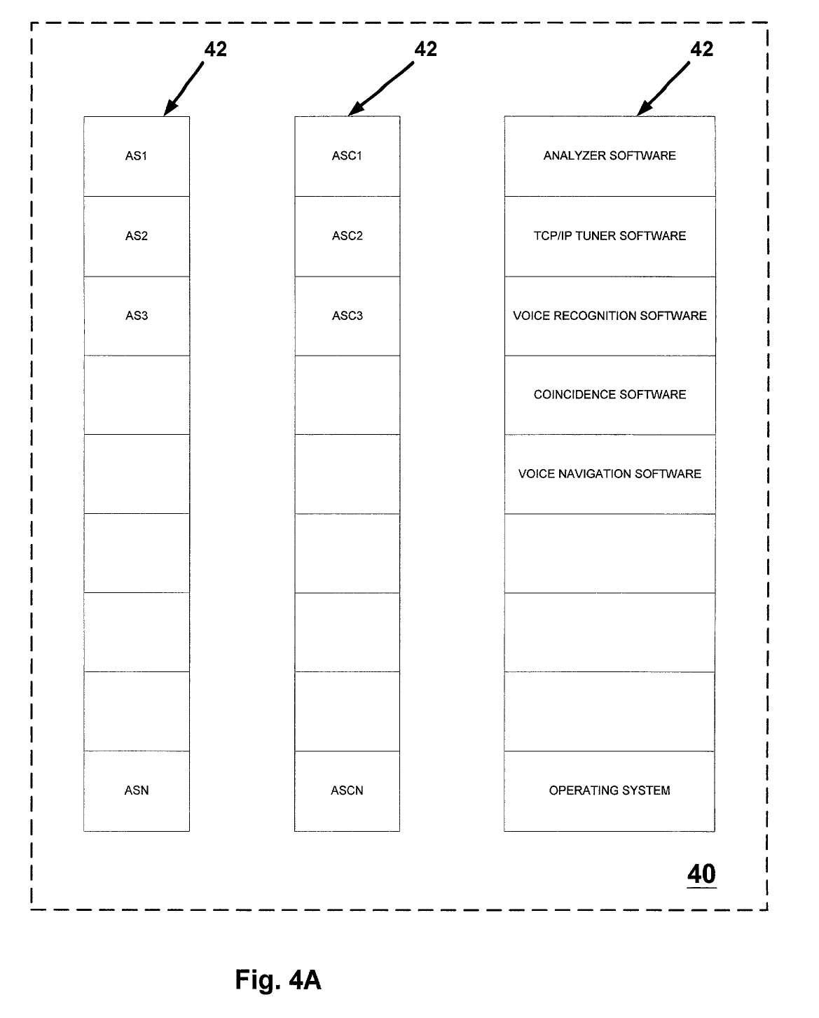

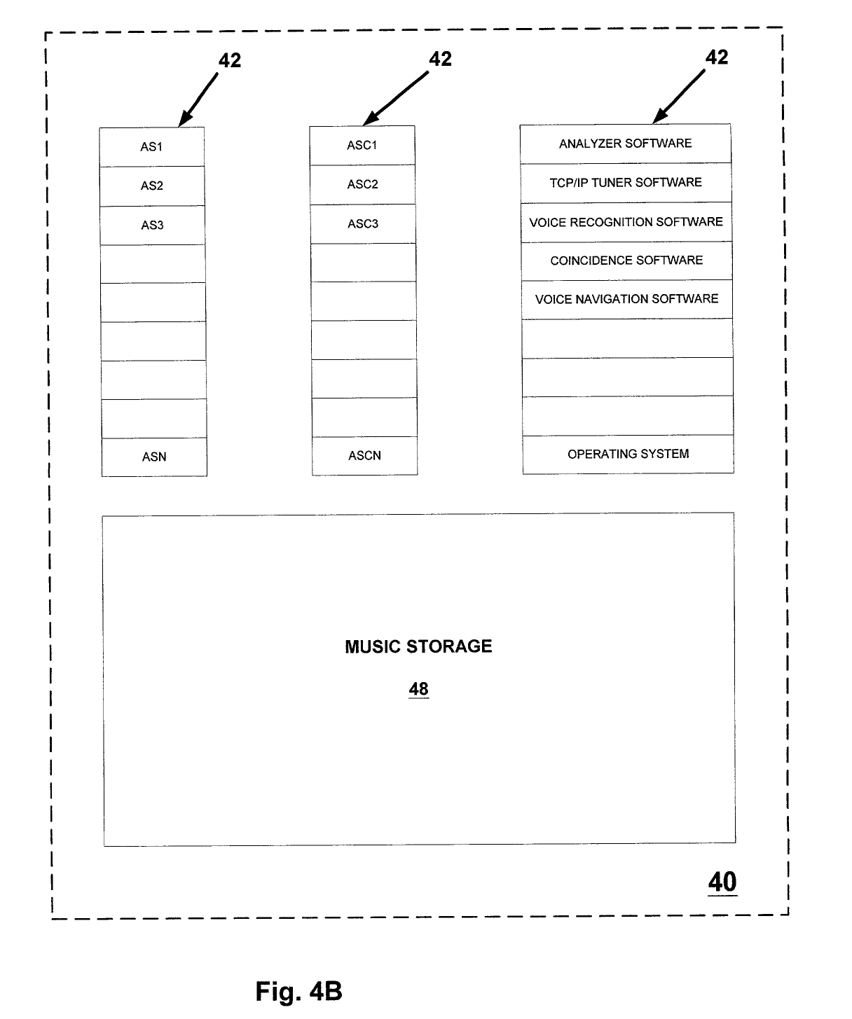

Before describing the rest of the steps in the operating method for the audio recorder-player 1 (100), it might be useful to discuss the organization of, for example, memory 40, which advantageously provides the functions attributed to RAM 42, NVRAM 44, and ROM 46. From FIG. 4A, it will be appreciated that ROM 46 or an equivalent portion of memory 40 advantageously stores software programs and routines which can be performed by or instantiated on the processor 30. It will also be appreciated that only one copy of a program need be stored provided multiple copies of a routine, e.g., the TPC/IP tuner software, can be instantiated simultaneously. In contrast, the RAM portion of the memory 40 is organized into bins, caches, buffers, or queues AS1-ASN for receiving audio signal samples from the tuners. Multiple storage locations are provided, one for each of the audio signal sources that are to be sampled. For each cache or buffer established in the RAM portion of the memory 40, there is a corresponding NVRAM portion ASC1-ASCN in which the audio signal characteristics for a corresponding audio signal sample is stored.

FIG. 4B illustrates an alternative memory configuration where a significant portion of the memory 40 (140) is segregated into a bulk music storage area 48. It will be noted that when a large hard drive, e.g., greater than 1 GB, the storage area may be omitted in favor of increasing the sample storage caches AS1-ASN to the point where at least some of these caches or buffers can contain minutes, and preferably hours, of material from the user's favorite audio sources, with or without compression. It should be mentioned at this point that since the various caches AS1-ASN and ASC1-ASCN are established by the audio recorder-player, the size of each cache may be set arbitrarily. For example, the cache AS1 may store audio signal samples or segments from an “all talk” or “all weather” audio source (station), requiring a relatively small sample size. However, the user-established keywords, words of phrases that are of interest to the user, may be so extensive that the number of audio signal characteristics may require that the area in memory 44 corresponding to the memory 42 dedicated to that audio source is larger than the area allocated to that audio source. Other arrangements are possible and all such arrangements are considered to within the scope of the present invention.

It will be appreciated that when the audio recorder-player 1 is incorporated into a radio in an automobile, the cache size can be restricted in order to gather audio signal samples from all possible audio signal sources; as the user's preferences are learned by the audio recorder-player, the number or cache locations can be decreased in order to increase the size of the remaining caches. Stated another way, the audio recorder-player need not store audio signal samples from audio signal sources that the user is unlikely to play. For example, if the user simply does not enjoy opera and rap music, there is no point in analyzing transmissions from stations that specialize in opera and rap music.

Referring again to FIG. 3, during step S12, audio samples (or programs) advantageously are obtained from the available audio signal sources or a subset thereof. It will be appreciated that the sampling advantageously can be performed in parallel when there are several real or virtual tuners, e.g., tuners 20 and 22 or TCP/IP tuners 120a-120n, available. For example, when the user is operating the CD player of an automobile entertainment system incorporating an audio recorder-player 1 according to the present invention, both of the tuners 20 and 22 can be actively scanning for audio signal sources in background. When the user is listening to a station “pulled in” by the tuner 20, only the tuner 22 is available to perform the audio sampling step. It will be noted that the processor 130 of audio recorder-player 100 merely instantiates the number of TCP/IP tuners 120a-120n commensurate with the other functions being performed. For example, when the audio recorder-player 100 is incorporated into a personal computer, and that computer is being employed as a word processor, the processor 130 can instantiate TCP/IP tuners (and other software devices) until the performance of the word processing routine begins to degrade. It will be noted that, in that case, when the user starts his/her spreadsheet program, the processor 130 unloads, i.e., kills, one or more of the TCP/IP tuners to maintain the performance level of the computer.

It should be mentioned that, since there are only a limited number of real or even virtual tuners, and since an audio source cannot be characterized with one long, continuous sample as well as it can be with several audio sample segments covering a longer time period, the available tuners may scan through the available audio signal sources repeatedly. Thus, each time an N^{th} audio signal source is selected, an audio signal segment is stored in ASN for subsequent analysis. In contrast, after the user's preferences are learned by the audio recorder-player 1 (100), the audio recorder-player advantageously can record minutes or even hours of content from a preferred audio source so that material is available for playback when, for example, the preferred audio source is unavailable, e.g., when the user is traveling and his/her favorite radio station cannot be received.

During step S14, the audio recorder-player analyzes the stored audio signal samples and generates one or more data identifying audio signal characteristics. For example, the audio signal samples or segments stored in AS1 advantageously can be processed by either speech recognition software or music classification software, or both. It will be appreciated that when the audio signal samples are to be subjected to both types of processing, such processing is preferably performed in parallel. However, serial processing is not excluded. Moreover, when previously stored audio signal characteristics indicates that a particular audio signal source, e.g., station, is an “all talk” audio signal source, the audio recorder-player need not perform music classification processing, since the vast majority of “music” will be associated with advertisements. Additional details regarding the analysis and characterization routines performed during step S14 are provided below.

During step S16, the data corresponding to the audio signal characteristics in the audio signal samples stored in memory locations AS1-ASN of memory 40 are stored in corresponding memory location ASC1-ASCN. It will be appreciated that the audio signal characteristic data is persistent data, i.e., the data advantageously is retained through a power off event and initialization, i.e., step S10; the audio signal samples stored at memory locations AS1-ASN in, for example, RAM 42 are generally not available the next time the user energizes his/her automobile entertainment system incorporating the audio recorder-player.

Periodically, the audio recorder-player 1 (100) checks to see whether a command has been entered by the user. More specifically, a check is performed to determine whether a voice command has been entered by the user during step S18. Alternatively, or simultaneously, the audio recorder-player performs a check to determine whether a key command has been generated by, for example, the user activating a key in the control panel of the audio recorder-player (or in a remote control device associated with the audio recorder-player (not shown)) during step S20. When the answer at either or both of these checks are negative, the routine jumps back to the start of step S12 and begins to acquire additional audio signal segments or samples. However, when to results of either check is affirmative, the routine jumps to step S22.

During step S22, a tuner control signal (TCS) is generated which corresponds to the command input during either step S18 or step S20. This signal is applied to a predetermined tuner, e.g., tuner 20 or TCP/IP tuner 120a, to cause the tuner to jump to the audio signal source identified in the TCS during step S24. It will be appreciated that the TCS advantageously can include instruction regarding the manner, e.g., volume, bass, and treble settings, etc., at which the audio signal is to be played by the tuner.

During step S26, a check is performed to determine whether a shutdown command has been applied to the audio recorder-player 1 (100). The shutdown command could take the form of an operation of the entertainment system's power button. Alternatively, particularly in the case of audio recorder-player 100, it could take the form of the intentional shutdown (or loss) of the user's Internet connection. It will be appreciated that the shutdown command can be provided by the processor 130 itself whenever, for example, the user starts sufficient other programs that there are not enough processor resources to instantiate the various audio recorder-player software modules. In any event, when the outcome of the determination is negative, the operating method steps back to the beginning of step S12. When the outcome is affirmative, the audio recorder-player shuts down during step S28.

Thus, audio recorder-player according to the present invention provides a system which can automatically scan through different radio (or internet radio) programs and collect audio signal samples from each radio station or audio signal source. Moreover, the audio recorder-player advantageously can perform audio personalization functions, e.g., pause, and search and/or classify the collected audio signal samples. When incorporated into an automobile's entertainment system, the audio recorder-player can automatically scan and classify the content into music or speech.

It will be appreciated that audio segmentation and classification includes division of the audio signal into portions corresponding to different categories, e.g. speech, music, etc. The first step is to divide a continuous bit-stream of audio data into different non-overlapping segments such that each segment is homogenous in terms of its class. Each audio segment is then classified using low-level audio features such as bandwidth, energy, and pitch, as discussed in detail above. Audio segmentation and classification is known in the art and is generally explained in the publication by D. Li, I. K. Sethi, N. Dimitrova, and T. Mcgee entitled “Classification Of General Audio Data For Content-Based Retrieval,” Pattern Recognition Letters, pp. 533-544, Vol. 22, No. 5, April 2001, the entire disclosure of which is incorporated herein by reference. The paper addresses the problem of segmenting and classifying continuous generalized audio data into seven categories by classification features. The seven audio categories used in the audio recorder-player according to the present invention include silence, single speaker speech, music, environmental noise, multiple speakers' speech, simultaneous speech and music, and speech and noise. Advantageously, the paper presents the fundamental definitions and algorithms applicable to the low level feature detection used for the extraction of six sets of acoustical features, including Mel Cepstral Frequency Coefficients (MFCC), Linear Predictive Coding coefficients (LPC), delta MFCC, delta LPC, autocorrelation MFCC, and several temporal and spectral features.

It should be mentioned that additional details regarding classification and feature extraction with respect to audio signal samples and segments are disclosed in, for example, U.S. Pat. Nos. 5,918,223 and 6,320,623 B1. In particular, U.S. Pat. No. 6,320,623 discloses a television which triggers an event, e.g., a channel switching event, when a predetermined audio event is detected with the aid of an auxiliary tuner, i.e., a picture-in-picture (PIP) tuner, coupled to a data and sound detector. In addition, U.S. Pat. No. 5,918,223 discloses a device for performing analysis and comparison of audio data files. It will be appreciated that the latter patent employs the above-mentioned MFCC algorithms in performing feature extraction, i.e., generation of feature vectors. Moreover, the paper by Serhan Dagtas and Mohamed Abdel-Mottaleb entitled “Extraction of TV Highlights using Multimedia Features,” Proceedings International Workshop on Multimedia Signal Processing, October 2001 (Cannes, France) provides additional details regarding feature extraction.

Furthermore, the music from the available audio sources can be classified and the audio recorder-player controlled so that one of the tuners stays on a station that corresponds to the personal profile of a user. For example, if the user is a jazz aficionado, the automobiles entertainment system will remain tuned to a jazz station as the automobile travels from one broadcast region to another. It will be appreciated that the switch between first and second stations can be coordinated by the audio recorder-player to avoid perceptible discontinuities in the music stream, e.g., the switch either can occur when the two stations are playing commercials or gaps can be filled with jazz already stored in the audio recorder-player's memory. In any event, the audio recorder-player can be put into this particular operating mode when the user issues a high level voice command such as “find something nice,” where “nice” corresponds to one or more categories of music associated with that user.

With respect to radio news stations, the audio recorder-player advantageously can provide search mechanism for items that are missed or items that are interest to the user. These items may be predetermined or established “on the fly.” Preferably, the news can be stored and forwarded to the user's PDA or cell phone for later playback (in either audio or textual formats) or cached and continued the next day, i.e., the next time the user drives his/her automobile. It will be appreciated that this operating mode can be extended to record updated reports on weather and traffic for immediate playback, which would eliminate the waiting for the current report to come on or hearing an outdated report. It will be noted that dedicated keys and high-level voice commands corresponding to “instant weather” or “instant scores” could be incorporated into the audio recorder-player.

It should also be noted that, in scanning mode, the audio recorder-player advantageously can monitor certain channels and alert the user when certain user-identified events occur. An example scenario for this is that while the user is listening to a news channel, the scanner monitors several channels broadcasting several different sporting events, e.g., broadcasts of several college basketball or football games. The audio recorder-player briefly switches to those channels and outputs the respective audio signal whenever an interesting event occurs, e.g., the announcer indicates that a “touchdown” has been scored or the game is going into overtime.

Stated another way, the audio recorder-player outputs one of the monitored audio signals whenever a “global” audio signal characteristic, which advantageously can be stored in memory 44 (144), is satisfied, i.e., recognized as being characteristic of one of the audio signals being monitored. It will be appreciated that the event need not be detected by analysis via a voice recognition software module; the events may be general interesting events identified audio signal samples indicative of crowd excitement level. In any case, the audio recorder-player according to the present invention provides event detection and monitoring feature to the user in an automated fashion.

In addition, the audio recorder-player can add identified content to its repository in an automated fashion. For example, the monitored audio sources (channels or stations) can be buffered given sufficient memory. Beneficially, when the user chooses to record a program, the beginning point of the current song is detected and the entire program is recorded. On the contrary, when the user wishes to skip a current live program, recorded material can be replayed to ensure enhanced user experience. It will be appreciated that the audio recorder-player can optimize the amount of stored music by culling repeated songs or eliminating commercials as well as news, weather, and traffic reports. The user can also eliminate unwanted songs from memory via another high-level voice command. Given that user will consider all, or at least most, of the songs stored in memory 40 of audio recorder-player 1 to be appealing, the audio recorder-player advantageously can respond to the “nice” criteria with a random selection of music when no stations are available. In short, since the audio recorder-player has multiple tuners and memory for program material storage, the audio recorder-player advantageously provides a time-warping capability.

Preferably, the audio recorder-player is generally scanning and storing audio signal samples or segments for multiple audio sources and, thus, the amount of music stored should be only a few seconds. This is enough of an audio signal sample for the audio recorder-player to extract audio features, perform speech to text conversion for the speech segments, and analyze the audio content. It will be noted that once the features are extracted from the audio, the audio recorder-player advantageously can perform the classification and summarization functions. These functions are then used for personalizing the audio recorder-player to provide enhanced scanning, retrieval, store, and forward functions. Exemplary functions of the audio recorder-player according to the present invention include:

1) MUSIC CLASSIFICATION PLAYBACK FUNCTION: The audio recorder-player is capable of recognizing audio features that can be used to identify the type of music based on beat, energy, pitch, the type of melodies, repetition of melodies, etc. This can be subgenera of music that is particularly appealing to the user. Although radio stations are categorized into jazz, soft, classical, rock, this classification scheme is often too broad for many users, i.e., there are still artists or songs that the user would rather not hear. The audio recorder-player can assist the user in selecting songs or content of interest when the user provides the audio recorder-player with particular examples by, for example, pressing a “like” button on a number of songs in the music styles that the user likes. It will be appreciated that this could occur as the user listens to music output by the audio recorder-player or during a preview session where the user listens to a predetermined portion, i.e., 15 seconds, of a number of music pieces.

2) WATCHDOG FUNCTION: The user can sing or hum a pattern to the audio analyzer in the audio recorder-player and then the audio recorder-player can monitor different channels for that particular tune. Moreover, the user can input spoken words to the audio recorder-player via the voice recognition software and then the audio recorder-player can monitor different channels for conversations and monologues containing some or all of those words. It will be appreciated that advanced matching algorithms, i.e., an algorithm that declares a match when the phrase occurs twice or thrice in a predetermined number of seconds, can also be instantiated by the processor 30 (130).

3) NEWS REVIEW FUNCTION: The audio recorder-player advantageously can summarize all the news segments that are of interest to the user, while skipping over non-interesting items. In fact, the audio recorder-player can be set to replay only the digested versions of news, i.e., only news that has been processed by the voice recognition software. At the user's request, the audio recorder-player can play back the whole story, or even link to an even longer version, which can be downloaded automatically from a web site. It will be appreciated that many voice recognition software programs have text-to-voice capabilities; thus, the audio recorder-player can down a long text file and then read it to the user. Moreover, the audio recorder-player can summarize news on different channels and offer the quick summary option when the user wants to retrieve news. This function can be accessed through a voice recognition user interface.

4) TIME SHIFT FUNCTION: The audio recorder-player can also store songs or news or programs (say Schikely mix on Saturdays) and then retrieve them via specialized voice commands if the user is listening to another station or does not have the radio on.

5) AUTO-PILOT FUNCTION: the audio recorder-player can identify the user via audio speaker identification and enter autopilot mode during in which the audio recorder-player behaves in a manner similar to the way that the user would operate the audio recorder-player, i.e., the audio recorder-player first scans through news and then plays classical music (if it is morning) or rock favorites (if it is early evening) because that is what the user routinely does when she/he operates the automobile entertainment system containing the audio recorder-player.

It should be mentioned that the audio signal characteristics and can include genre information, which is typically stored in MP3 files, and which may accompany/identify some streaming audio tracks. The genre information can be either a numeric value or a string, e.g. “newage” or “New Age,” that is easily readable by the audio recorder-player familiar with interpreting the file or stream without any serious processing. It will be appreciated that this is how the user sees “now playing” information when listening to streaming audio channels off the Internet; the user receives song title, artist, etc. Additional predetermined characterization information can be transmitted to the audio recorder-player to supplement or compliment the analysis and characterization performed by software instantiated by the processor 30 (130).

In addition, it will also be appreciated that radio stations and signal standards in Europe beginning in the early 1990's allowed “enabled” radios to obtain information about the radio stations, including call letters. Once a radio is tuned to a programmed service broadcast within a network, using the RDS (Radio Data System) feature Enhanced Other Networks (EON) additional data about other programs from the same broadcaster will be received. This enables the listener, according to his choice, to have his radio operating in an automatic switch-mode for travel information or a preferred Program Type (PTY, e.g. News) and this information comes from a service that, at a given time, does not necessarily contain such travel information nor even broadcasts the desired program type. This additional data advantageously can be incorporated into the audio signal characteristic. It will be noted that while several radio stations in the United States operate on the same frequency in different geographic regions, all stations employ unique call letters. Thus, an automobile equipped with the audio recorder-player according to the present invention would be able to store audio characteristic data on rock station 99 FM and jazz station 99 FM operating in separate markets.

In short, the audio recorder-player according to the present invention permits automated monitoring of audio channels (analog and digital broadcast, internet or otherwise) and enhances the user listening experience by allowing auto-recording or playing back of program material from multiple live and recorded audio sources.

It will be noted that numerous patents were discussed above. Each of these patents is incorporated herein by reference in its entirety.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. An audio recorder-player, comprising:
means for tuning to at least two audio sources to thereby generate first and second audio signals;
means for generating first and second audio signal characteristics responsive to the first and second audio signals;
means for storing both the first and second audio signals and the first and second audio signal characteristics; and
means for reproducing one of the first and second audio signals responsive to selection of one of the first and second audio signal characteristics.

2. The audio recorder-player as recited in claim 1, wherein the audio recorder-player is included in a radio.

3. The audio recorder-player as recited in claim 1, wherein the audio recorder-player is included in a computer.

4. The audio recorder-player as recited in claim 1, wherein the audio recorder-player is included in a set-top box.

5. The audio recorder-player as recited in claim 1, wherein the storing means comprises a hard disk.

6. The audio recorder-player as recited in claim 1, wherein the tuning means comprises software routines instantiated by a processor.

7. The audio recorder-player as recited in claim 1, wherein the generating means comprises a voice recognition routine instantiated by a processor.

8. The audio recorder-player as recited in claim 1, further comprising:
means for applying a control signal generated in response to a spoken command to thereby control the reproducing means.

9. An audio recorder-player, comprising:
means for tuning to at least two audio sources to thereby generate first and second audio signals;
means for generating N audio signal characteristics including silence, single speaker speech, music, environmental noise, multiple speakers' speech, simultaneous speech and music, and speech and noise for both the first and second audio signals;
means for storing both the first and second audio signals and the first and second audio signal characteristics; and
means for reproducing one of the first and second audio signals responsive to selection of one of the N audio signal characteristics.

10. An audio recorder-player, comprising:
M tuners that generate N audio signals transmitted by N audio sources;
an analyzer that extracts R×N audio signal characteristics from the N audio signals;
a memory that stores the R×N audio signal characteristics; and
output circuitry that reproduces an audio signal corresponding to one of the N audio signals responsive to selection of at least one of the R×N audio signal characteristics,
where R is a positive integer and M and N are positive integers greater than 1.

11. The audio recorder-player as recited in claim 10, wherein the memory comprises a hard disk.

12. The audio recorder-player as recited in claim 10, wherein each of the M tuners comprises a software routine instantiated by a processor.

13. The audio recorder-player as recited in claim 10, wherein the analyzer comprises a voice recognition routine instantiated by a processor.

14. The audio recorder-player as recited in claim 13, wherein the voice recognition routine generates signals that control the output circuitry in response to a spoken command.

15. An operating method for an audio recorder-player including M tuners, an analyzer, a storage device, and audio output circuitry, comprising:
operating the M tuners to acquire N audio signals from N audio sources;
operating the analyzer to characterize the N audio signals and generate R×N audio signal characteristics;
storing both the N audio signals and the R×N audio signal characteristics in the storage device; and
reproducing a selected one of the N audio signals via the audio output circuitry responsive to selection of one of the R×N audio signal characteristics,
where R is a positive integer and M and N are positive integers greater than 1.

16. The operating method as recited in claim 15, wherein M is equal to N.

17. The operating method as recited in claim 15, wherein:
one of the N audio signals is stored while one of the M tuners is tuned to a respective one of the N audio sources; and
the R×N audio signal characteristics are extracted from the stored N audio signals.

18. The operating method as recited in claim 15, wherein selected ones of the R×N audio signal characteristics correspond to tempo, tone, and energy for music included in the N audio signals.

19. The operating method as recited in claim 15, wherein selected ones of the R×N audio signal characteristics correspond to words extracted from speech included in the N audio signals.

20. The operating method as recited in claim 15, further comprising:
generating a control signal for causing the audio output circuitry to reproduce the selected one of the N audio signals responsive to a user selected one of the R×N audio signal characteristics.

21. An operating method for an audio recorder-player including M tuners, an analyzer, a storage device, and audio output circuitry, comprising:
operating the M tuners to acquire N audio signal segments from N audio sources;
operating the analyzer to characterize the N audio signal segments and generate R×N audio signal characteristics;
storing the R×N audio signal characteristics in the storage device; and
reproducing audio signals generated by a selected one of the N audio sources via the audio output circuitry responsive to selection of one of the R×N audio signal characteristics, where R is a positive integer and M and N are positive integers greater than 1.

22. The operating method as recited in claim 21, wherein M is equal to N.

23. The operating method as recited in claim 21, wherein:
one of the N audio signal segments are temporarily stored each time one of the M tuners is tuned to a respective one of the N audio sources; and
the R×N audio signal characteristics are extracted from the temporarily stored N audio signal segments.

24. The operating method as recited in claim 21, wherein selected ones of the R×N audio signal characteristics correspond to tempo, tone, and energy for music included in the N audio signal segments.

25. The operating method as recited in claim 21, wherein selected ones of the R×N audio signal characteristics correspond to words extracted from speech included in the N audio signal segments.

26. The operating method as recited in claim 21, further comprising:
generating a control signal for causing the audio output circuitry to reproduce the selected one of the N audio signals responsive to a user selected one of the R×N audio signal characteristics.

27. The operating method as recited in claim 21, further comprising:
generating a control signal for causing the audio output circuitry switch between an output one of the N audio signals and a monitored one of the N audio signals whenever a audio signal sample indicative of the occurrence of an event of interest to a user.

28. A memory storing computer readable instructions for causing a processor associated with an audio recorder-player to instantiate at least one of predetermined functions including:
a music classification function permitting the audio recorder-player to automatically classify music in received audio signals based on audio features,
a watchdog function permitting the audio recorder-player to automatically respond to the occurrence of a predetermined audio event,
a news review function permitting the audio recorder-player to accumulate and play audio signals corresponding to news of interest to the user of the audio recorder-player,
a time shift fiction permitting the audio recorder-player to record audio signal programs to be played at a later time, and
an auto pilot function permitting the audio recorder-player to automatically operate based on an operational preference pattern established by the user.
